(19) United States
(12) Patent Application Publication
(10) Pub. No.: US 2014/0213270 A1
(43) Pub. Date: Jul. 31, 2014

(54) Method and Device for Capacity Management

(71) Applicant: Telefonaktiebolaget LM Ericsson (publ), Stockholm (SE)

(72) Inventors: Wanxin He, Nanjing (CN); Eric Wang, Nanjing (CN)

(73) Assignee: TELEFONAKTIEBOLAGET L M ERICSSON (PUBL), Stockholm (SE)

(21) Appl. No.: 13/818,205

(22) PCT Filed: Jan. 25, 2013
(86) PCT No.: PCT/CN13/70966

§ 371 Date: Feb. 21, 2013

(51) Int. Cl. H04W 72/04

(52) U.S. Cl. CPC H04W 72/0433
USPC 455/452.1; 455/560; 455/561

(57) ABSTRACT

The embodiments disclose a method performed in a Radio Network Controller, RNC, in a radio communication network including at least one RNC and at least one Radio Base Station, RBS, and a plurality of user equipments, UEs. The method introduces cooperation between the RNC and other devices which have the related information about Enhanced Uplink, EUL and/or High Speed Downlink Packet Access, HSDPA, user number of said RBS. The method comprises: receiving a message, which includes the information about EUL and/or HSDPA user number of said RBS; using said information about EUL and/or HSDPA user number of said RBS for the RNC's capacity management. The embodiments also disclose a RNC thereof.

### TECHNICAL FIELD

The present technology generally relates to radio communication, particularly to a method for capacity management and the device thereof.

### BACKGROUND

In a typical cellular radio communication system, mobile user equipments (UEs), communicate via a radio access network (RAN) to one or more core network nodes.

RAN covers a geographical area which is divided into cell areas, with each cell area being served by a Radio Base Station (RBS). A cell is a geographical area where radio coverage is provided by the radio base station equipment at a base station site. The RBSs communicate over the air interface (e.g., radio frequencies) with the UEs within range of the RBSs. In the RAN, several RBSs are typically connected (e.g., by landlines or microwave) to a RNC. The RNC, also sometimes termed a base station controller, BSC, supervises and coordinates various activities of the plural base stations connected thereto. The RNCs are typically connected to one or more core networks.

One example of a RAN is the Universal Mobile Telecommunications (UMTS) Terrestrial Radio Access Network (UTRAN). The UMTS is a third generation system which in some respects builds upon the radio access technology known as Global System for Mobile communications, GSM developed in Europe. UTRAN is essentially a radio access network providing Wideband Code Division Multiple Access, WCDMA, to UEs. The Third Generation Partnership Project, 3GPP, has undertaken to evolve further the UTRAN and GSM-based radio access network technologies.

As the demand grows for higher throughput, i.e., higher bit rate, and more efficient transmission of packet data over wireless networks, 3GPP has extended its specifications with the High Speed Downlink Packet Access (HSDPA), for transfer of packetized data in the downlink direction—from the RNC to the RBS (e.g., Node-B) and eventually to the UE. HSDPA's main goal is to enhance network capacity through increased accessibility, increased throughput, and reduced latency in the downlink direction. High Speed Downlink Shared Channel (HS-DSCH) is a new sharing transport channel type. HSDPA utilizes as its transport channel the HS-DSCH.

In the uplink direction—from the UE to the Node-B, the 3GPP has also extended its specifications with Enhanced Uplink (EUL). EUL provides improved uplink performance in terms of increased user data rates and increased capacity through new features, such as multi-code transmission, short transmission time interval (TTI), fast hybrid automatic repeat request (HARQ), and fast scheduling. Enhanced Dedicated Channel (E-DCH) is a new dedicated transport channel type or enhancements to an existing dedicated transport channel type. EUL utilizes as its transport channel the E-DCH. The E-DCH co-exists in the uplink with the Release 99 DCH.

Channel switch is used in such systems to optimize the utilization of radio resources, which switches a UE to the most suitable transport channel based on throughput, radio resources availability, radio conditions and mobility. This scheme is limited to packet switch service. Due to limitation in resources, the HSDPA and EUL user numbers should be controlled. “User number” is to be understood as the number of users hereof.

Those skilled in the art appreciate that, with respect to a certain RAN-UE connection, an RNC can either have the role of a serving RNC (SRNC) or the role of a drift RNC (DRNC). If an RNC is a SRNC, the RNC is in charge of the connection with the UE, e.g., it has full control of the connection within the RAN. A SRNC is connected to the core network. On the other hand, if an RNC is a DRNC, its supports the SRNC by supplying radio resources (within the cells controlled by the DRNC) needed for a connection with the UE. A RNC is said to be the Controlling RNC (CRNC) for the RBSs connected to it by an Iub interface. This CRNC role is not UE specific. The CRNC is, among other things, responsible for handling radio resource management for the cells in the RBSs connected to it by the lub interface.

In such systems, RNC is responsible for admission control while RBS is mainly responsible for license and hardware capability control. When setting up or adding one or more E-DCH(s) or HS-DSCH(s), or up switch (the term “up switch” is used to define a channel switch to a channel with higher capacity hereof) from DCH to E-DCH or HS-DSCH, SRNC will send a RNSAP signaling message to DRNC, where the admission control is performed, to request a radio link setup or addition or reconfiguration, and in turn to RBS in case that the new EUL or HSDPA user(s) is/are admitted by RNC. If EUL or HSDPA user number configured in RNC is sufficient but limited in RBS, DRNC will get the failure reason of “nodeB-Resources-unabailable”, and keep trying to setup or add or reconfigure (referred to as configure hereinafter). Thus bad user feeling and experience may occur. When setting up or adding one or more E-DCH(s) and HS-DSCH(s), or up switch from DCH to E-DCH and HS-DSCH, SRNC will send one RNSAP signaling message to DRNC, where the admission control is performed, to request a radio link setup or addition or reconfiguration for both E-DCH and HS-DSCH, and in turn to RBS in case that the new EUL or HSDPA user(s) is/are admitted by RNC. If EUL or HSDPA user number configured in RNC is sufficient but any of them limited in RBS, DRNC will get the failure reason of “nodeB-Resources-unabailable”, and keep trying to setup or add or reconfigure. Again, bad user feeling and experience may occur. Besides, insufficiency of any one of EUL and HSDPA user numbers in RBS will cause setup or addition or reconfiguration of both EUL and HSDPA to fail, resulting in insufficient network performance.

### SUMMARY

Therefore, it is an object to solve at least one of the above-mentioned problems.

According to one aspect of the embodiments, there is provided a method performed in a Radio Network Controller (RNC), in a radio communication network including at least one RNC and at least one Radio Base Station (RBS), and a plurality of user equipments (UEs). The method introduces cooperation between the RNC and other devices which have the related information about Enhanced Uplink (EUL) and/or High Speed Downlink Packet Access (HSDPA) user number of said RBS. The method comprises: receiving a message, which includes the information about EUL and/or HSDPA user number of said RBS; using said information about EUL and/or HSDPA user number of said RBS for the RNC's capacity management.

According to another aspect of the embodiments, there is provided a Radio Network Controller (RNC), in a radio communication network including at least one RNC and at least one Radio Base Station (RBS), and a plurality of user equipments (UEs). The RNC comprises: a transceiver, configured to send and receive messages, including to receive a message which has the information about Enhanced Uplink (EUL) and/or High Speed Downlink Packet Access (HSDPA) user number of said RBS; a storage, configured to store information used by said RNC; a processor, configured to use said information about EUL and/or HSDPA user number of said RBS for capacity management.

According to another aspect of the embodiments, there is provided a method performed in a Radio Base Station, RBS, in a radio communication network including at least one Radio Network Controller (RNC), and at least one RBS, and a plurality of user equipments (UEs), comprising: generating a message, which has the information about Enhanced Uplink (EUL) and/or High Speed Downlink Packet Access (HSDPA) user number of said RBS; and sending said message.

According to another aspect of the embodiments, there is provided a Radio Base Station (RBS) in a radio communication network including at least one Radio Network Controller (RNC) and at least one RBS, and a plurality of user equipments (UEs), comprising: a generator, configured to generate a message which has the information about Enhanced Uplink (EUL) and/or High Speed Downlink Packet Access (HSDPA) user number of said RBS; and a transceiver, configured to send said message.

According to a further aspect of the embodiments, there is provided a computer program product, which comprises the instructions for implementing the steps of the method as described above.

According to a still further aspect of the embodiments, there is provided a recording medium which stores instructions for implementing the steps of the method as described above.

As a whole or by scenario, it is advantageous to introduce cooperation between the RNC and another device, e.g., RBS, into capacity management. The RNC will be aware of the RBS's capacity information and take this into account for admission control, and/or will reduce the useless/unnecessary attempting for HS-DSCH and/or E-DCH setup or addition or up switch from DCH to HS-DSCH and/or E-DCH, and/or improve the efficiency and veracity of admission control. In some scenarios, RNC and RBS will be more supportive of the admission, obviating dispensable failures, thus rendering the RNC and RBS more flexible and robust. As a whole, the present invention makes the system more efficient on resource handling, packet switch service setup and channel switch. From the point of view of the users, their experiences are essentially improved.

### BRIEF DESCRIPTION OF THE DRAWINGS

The technology will now be described, by way of example, based on embodiments with reference to the accompanying drawings, wherein:

FIG. 1 illustrates a schematic view of the environment in which embodiments are implemented;

FIG. 2 illustrates a flowchart of a method performed in a RNC in accordance with one embodiment;

FIG. 3 illustrates a flowchart of a method performed in a RNC in accordance with another embodiment;

FIG. 4 illustrates a flowchart of a method performed in a RNC in accordance with yet another embodiment;

FIG. 5 illustrates a block diagram of a RNC in accordance with one embodiment.

### DETAILED DESCRIPTION

Embodiments herein will be described in detail hereinafter with reference to the accompanying drawings, in which embodiments are shown. This embodiments herein may, however, be embodied in many different forms and should not be construed as being limited to the embodiments set forth herein. The elements of the drawings are not necessarily to scale relative to each other. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

The present technology is described below with reference to block diagrams and/or flowchart illustrations of methods, apparatus (systems) and/or computer program products according to the present embodiments. It is understood that blocks of the block diagrams and/or flowchart illustrations, and combinations of blocks in the block diagrams and/or flowchart illustrations, may be implemented by computer program instructions. These computer program instructions may be provided to a processor, controller or controlling unit of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

Accordingly, the present technology may be embodied in hardware and/or in software (including firmware, resident software, micro-code, etc.). Furthermore, the present technology may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that may contain, store, communicate, propagate, or transport the program for use by or in connection with the instruction execution system, apparatus, or device.

Embodiments herein will be described below with reference to the drawings.

Hereinafter, the embodiments will be described in the context of UTRAN. However, such description is only exemplary, rather than restrictive, and the embodiments are also applicable to other types of network which exist for the present or will exist in the future as appropriate.

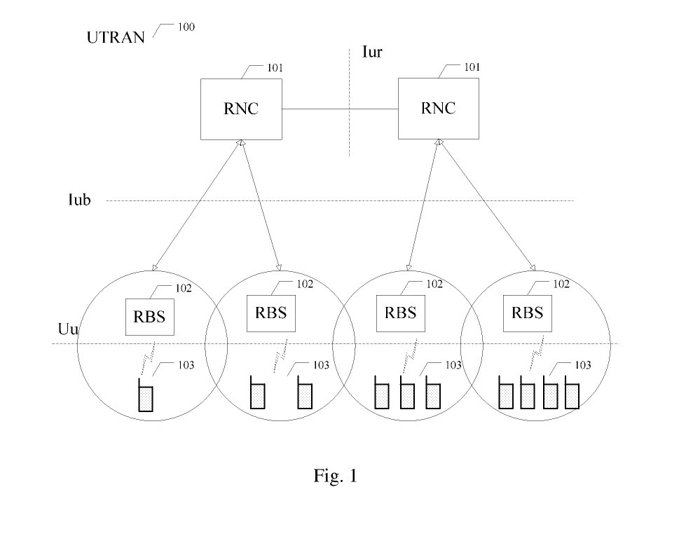

UTRAN 100 includes one or more radio network controllers (RNCs) 101. For sake of simplicity, the UTRAN 100 of FIG. 1 is shown with only two RNC nodes. Each RNC 101 is connected to a plurality of radio base stations (RBSs) 102. For example, and again for sake of simplicity, four RBSs 102 are shown, each connected to the RNC 101. In this regard, the left RNC serves the left two RBSs while the right RNC serves the right two RBSs. It will be appreciated that a different number of RBSs can be served by each RNC, and that RNCs need not to serve the same number of RBSs. Moreover, FIG. 1 shows that a RNC 101 can be connected over an Iur interface to one or more other RNCs in the UTRAN 100.

Here, the connections between RNCs 101 and between RNCs 101 and RBSs 102 may be implemented in wired or wireless way, or combination thereof.

Further, those skilled in the art will also appreciate that a radio base station (RBS) 102 is sometimes also referred to in the art as a base station, a macro base station, a femto base stations, a node B, or B-node, a eNodeB, etc., besides, also other transceivers or wireless communication stations used to communicate with the UEs.

In the illustrated environment, for sake of simplicity, each RBS 102 is shown as serving one cell. Each cell is represented by a circle which surrounds the respective RBS. It will be appreciated by those skilled in the art, however, that a RBS 102 may serve for communicating across the air interface for more than one cell. For example, two cells may utilize resources situated at the same RBS site.

A user equipment (UE), such as UE 103 shown in FIG. 1, communicates with one or more cells or one or more RBSs 102 over a radio or air interface. For simplicity and clarity, there are sets of 1, 2, 3, and 4 UE(s), each in a cell respectively. It will be appreciated that different numbers of UEs may be served by cells and the numbers served by different cells need not to be identical. The term “UE” used herein may indicate all forms of devices enabled to communicate via a communication network, such as mobile telephones (“cellular” telephones) and laptops with mobile termination, and thus can be, for example, portable, pocket, hand-held devices, such as mobile phones, smart phones, personal digital assistants (PDA); computer-included devices, such as desktops, laptops; vehicles, or other devices, such as meters, household appliances, medical appliances, multimedia devices, etc., which communicate voice and/or data with radio access network.

There are several interfaces of interest in the UTRAN 100. The interface between RNCs 101 is termed the “lur” interface. The interface between a RNC 101 and its RBSs 102, is termed the “lub” interface. The interface between the UEs 103 and the RBSs 102 is known as the “air interface” or the “radio interface” or “Uu interface”. Each of the Uu interface, the Iub interface, and the Iur interface is shown by dash-dotted lines in FIG. 1.

Different types of channels may exist between one of the RBSs 102 and UEs 103 for transport of control and user data. Some of the traffic channels can be common traffic channels, while others of the traffic channels can be dedicated traffic channels (DCHs). Enhanced Dedicated Channel (E-DCH) and High Speed Downlink Shared Channel (HS-DSCH) are new dedicated transport channel types or enhancements to an existing dedicated transport channel type.

The RNC 101 controls the UTRAN 100. In fulfilling its control role, the RNC 101 manages resources of the UTRAN 100. Such resources managed by the RNC 101 include (among others) the uplink and downlink user numbers, such as Enhanced Uplink (EUL) and High Speed Downlink Packet Access (HSDPA) user numbers.

The UTRAN 100 interfaces (Iu, Iur and Iub) have two planes, namely, a control plane (CP) and a user plane (UP). In order to control the UTRAN 100, the radio network applications in the different nodes communicate by using the control plane protocols. Node B Application Part (NBAP) signaling, which is defined in 3GPP TS 25.433, is a control plane protocol for the Iub interface. Radio Network Subsystem Application Part (RNSAP) signaling, which is defined in 3GPP TS 25.423, concerns the radio network layer signalling procedures of the control plane between RNCs in UTRAN, between RNC in UTRAN and BSS in GERAN (GSM EDGE Radio Access Network) Iu mode and between BSSs in GERAN Iu mode.

One of RNC's control roles is admission control of maximum of HSDPA and/or of EUL user in RNC capacity management. In a conventional embodiment, the capacity management is done by both the RNC 101 and the RBS 102.

In the embodiment, in RBS 102, when capacity license “number of HSDPA users per cell” is not installed, a default value is used instead to control the maximum of HSDPA user number per cell. If the parameter “max number of HSDPA user” is set to be higher than the default value, then the default value can be allowed for maximum of HSDPA user number per cell. If the parameter “max number of HSDPA user” is set to be less than the default value, then the set value is allowed for maximum of HSDPA user number per cell. On the other hand, if the capacity license “number of HSDPA users per cell” is enabled, maximum of HSDPA user number from the capacity license “number of HSDPA users per cell” is allowed for maximum of HSDPA user number per cell. Then the maximum of HSDPA user number from the capacity license “number of HSDPA users per cell” and the set value for “max number of HSDPA user” are compared so that the smaller one is determined for maximum of HSDPA user number per cell.

Still in the embodiment, in RNC 101, there is no license control, and the maximum of HSDPA user number per cell is limited by a separate configured parameter “number of HSDPA users per cell”.

In RAN environment, the RNC 101 first checks the local configured parameter “number of HSDPA users per cell”, if current number of HSDPA users is less than the local configured parameter value, then a NBAP message (e.g., RADIO LINK RECONFIGURATION PREPARE message) is sent to the RBS 102 to establish HS-PDSCH for HSDPA traffic.

When the RBS 102 receives the request, it will calculate how many HSDPA users already exist in its cell, and check whether the number has already reached the upper limit in RBS side. If current HSDPA user number does not reach the upper limit, then the RBS 102 assigns resource for the required HSDPA and EUL, and sends a NBAP message (e.g., RADIO LINK RECONFIGURATION READY message) in response to the RNC 101. If current HSDPA user number has already reached the upper limit, the RBS 102 will reject this request and send a NBAP message (e.g., RADIO LINK RECONFIGURATION FAILURE message) back to RNC 101, preferably with the reason “radioNetwork/nodeB-Resources-unavailable”.

Here, the set value, any of the default value and configured parameter value can be referred to as configured value. Similarly, capacity management of EUL users could be carried out in the same way mentioned above.

In current resource management strategy on RAN level, two NBAP procedures are very important. One is Audit related procedures, including Audit Required procedure and Audit procedure. The RBS initiates the Audit Required procedure to request the RNC 101 to perform an audit of the logical resources at the RBS. If the RBS cannot ensure alignment of the state or configuration information, it should initiate the Audit Required procedure. Upon receipt of the AUDIT REQUIRED INDICATION message, the RNC 101 should initiate the Audit procedure. A complete audit of a RBS 102 is performed by one or more Audit procedures, together performing an audit sequence. The audit may cause the RNC 101 to re-synchronize the RBS 102 to the status of logical resources known by the RNC 101, which the RBS 102 can support. The Audit Sequence procedure is initiated with an AUDIT REQUEST message sent from the RNC 101 to the RBS 102 and ended with an AUDIT RESPONSE message sent from RBS 102 to RNC 101.

The other is Resource Status Indication (RSI) procedure. When common physical channels and/or common transport channels have changed their capabilities at the Node, it will be triggered, and the Resource Status Indication message shall contain the logical resources affected and the cause value when applicable. This procedure is initiated with a Resource Status Indication message sent from the RBS 102 to the RNC 101.

One embodiment introduces cooperation between a RNC 101 and a RBS 102. In the embodiment, the RNC 101 receives a message (e.g. a NBAP message) from the RBS 102, which includes allowed maximum of EUL and/or of HSDPA user number of the RBS 102. Then the RNC 101 uses said information of allowed maximum of EUL and/or of HSDPA user number of the RBS 102 for the RNC's capacity management.

It should be appreciated that the RBS 102 is described by way of example to send the information of allowed maximum of EUL and/or of HSDPA user number of the RBS 102, while above message could be received from other devices directly which have the related information. Besides, above message could be received from the RBS 102 or said other devices directly, or relayed through other devices.

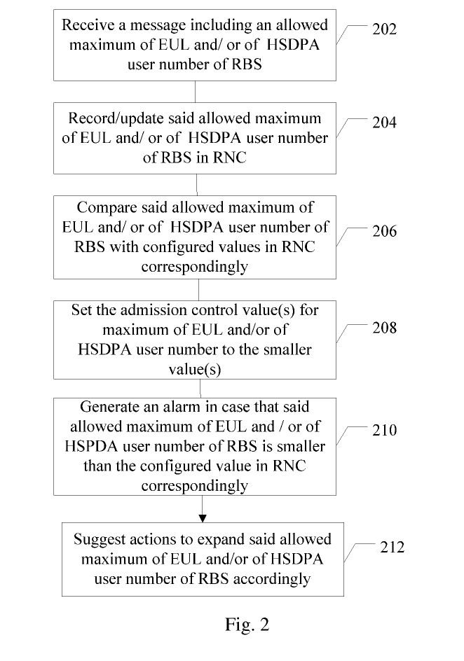

FIG. 2 illustrates a flowchart of a method performed in RNC 101 in accordance with the above mentioned embodiment. In step 202, The RNC 101 receives a message including an allowed maximum of EUL and/or of HSDPA user number of a RBS 102. In one example, the message is an AUDIT RESPONSE message sent from the RBS 102, in response to an AUDIT REQUEST message sent from the RNC 101 to the RBS 102. Alternatively, the message could be a RESOURCE STATUS INFORMATION message sent from the RBS 102. Both messages are NBAP messages, and new Information Elements (IEs) of allowed maximum of EUL and of HSDPA user number of a RBS should be added to NBAP messages.

It should be appreciated that the above messages are described by way of example, and any suitable message can be used in this embodiment. Besides, the allowed maximum of EUL user number and the allowed maximum of HSDPA user number probably appear in the same AUDIT RESPONSE message as required by an AUDIT RESPONSE message, but often appear in separate RESOURCE STATUS INFORMATION messages, as changes to allowed maximum of HSDPA user number and that of EUL user number seldom take place concurrently.

In step 204, the RNC 101 records said allowed maximum of EUL and/or of HSDPA user number of RBS 102 in RNC 101. Alternatively, if an allowed maximum of EUL and/or of HSDPA user number of RBS 102 has already been recorded in the RNC 101, then an update is performed in the step.

In step 206, a comparison is made between said allowed maximum of EUL user number of RBS 102 with corresponding configured parameter (e.g., termed as “max number of EUL user”) for maximum of EUL user number in RNC 101, and/or a comparison is made between said allowed maximum of HSDPA user number of RBS 102 with corresponding configured parameter (e.g., termed as “max number of HSDPA user”) for maximum of HSDPA user number in RNC 101, to determine the smaller value.

It should be appreciated that the above parameters could be rephrased similarly to indicate the actual meaning, or oppositely, as long as the RNC knows its representation.

In step 208, the RNC 101 sets the admission control value(s) for maximum of EUL and/or of HSDPA user number to the smaller value(s) from step 206 correspondingly.

Optionally, in case that said allowed maximum of EUL user number of RBS 102 is smaller than the configured value in RNC 101, the RNC 101 could generate an alarm to the operator telling this. Similarly, in case that said allowed maximum of HSDPA user number of RBS 102 is smaller than the configured value in RNC 101, the RNC 101 could generate an alarm to the operator telling this. This is shown in step 210.

Optionally, the RNC 101 may suggest to the operator actions to expand said allowed maximum of EUL and/or of HSDPA user number of RBS 102 accordingly. The actions may be ordering higher capacity license for HSDPA and/or EUL user number or expanding configured value for the allowed maximum of EUL and/or of HSDPA user number of the RBS 102. This is shown in step 212.

It should be appreciated that the above actions are described by way of examples, and any suitable action can be taken in this embodiment, and that the above alarms could be separate alarms, or just one alarm telling both.

Generally, the alarm option could be chosen by the operator and/or customer as desired, or be configured in any suitable way as appropriate.

Alternatively, the RNC 101 may take actions to automatically respond to the above cases in the embodiment, without intervening by the operator, and any suitable action can be performed in any suitable way in this embodiment.

The order in which some or all of the steps appear in each embodiment should not be deemed limiting. Rather, it should be understood by a person of ordinary skill in the art having the benefit of the instant disclosure that some of the step blocks may be executed in a variety of orders not illustrated.

As a whole, by means of cooperation between the RNC and the RBS, the RNC can add said allowed maximum of EUL and/or of HSDPA user number of the RBS as one of the evaluated criteria in its own admission control, then useless attempting for channel switch from DCH to E-DCH/HS-DSCH will be avoided, resulting in a more accurate and highly effective admission control. Besides, RNC and RBS will be more supportive of the admission, obviating dispensable failures, thus rendering the RNC and RBS more flexible and robust. Meanwhile, with the alarm presented, the system efficiency can be improved pointedly and effectively.

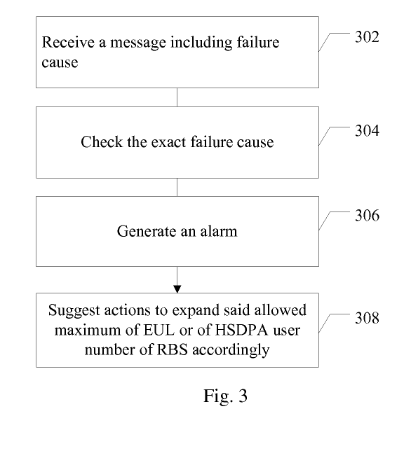

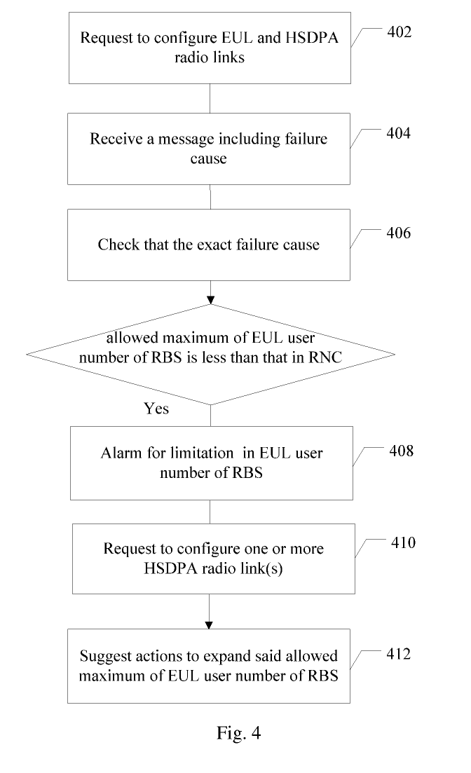

In another embodiment, the failure cause is detailed, to include specific causes of “MaxNumEulUsers not available”, which stands for that the EUL capability is present, but there are insufficient EUL resources to perform the requested action, and “MaxNumHsUsers not available”, which stands for that the HSDPA capability is present, but there are insufficient HSDPA resources to perform the requested action. The specific reason for insufficient resources is the limitation of the maximum of EUL user number and/or of HSDPA user number. FIGS. 3 and 4 illustrates flowcharts of methods performed in RNC 101 in accordance with this embodiment. During a HS-DSCH or E-DCH setup process or addition process or up switch process from DCH to HS-DSCH or E-DCH, if the maximum of HSDPA or of EUL user number of the RBS 102 is less than the corresponding configured parameter value in RNC 101, a radio link setup failure or addition or reconfiguration failure will occur, and the RNC 101 will be informed the specific failure cause of “MaxNumHsUsers not available” or “MaxNumEulUsers not available” indicating the exact failure cause. Specifically, during a HS-DSCH and E-DCH setup process or addition process or up switch process from DCH to HS-DSCH and E-DCH, the RBS 102 will first check the resources for HSDPA users to determine whether HSDPA user number in RBS side has reached the upper limit. If current HSDPA user number in RBS side has already reached the upper limit, the RBS 102 will inform RNC 101 with the specific failure cause of “MaxNumHsUsers not available”, without any further checking of the resources of EUL users. On the other hand, if current HSDPA user number in RBS side hasn't reached the upper limit, then the RBS 102 will go on to check the resources for EUL users to determine whether EUL user number in RBS side has reached the upper limit. Again, if current EUL user number in RBS side has already reached the upper limit, the RBS 102 will inform RNC 101 with the specific failure cause of “MaxNumEulUsers not available”.

FIG. 3 illustrates a flowchart of a method performed in RNC 101 in accordance with another embodiment. In step 302, the RNC 101 receives a message including the failure cause of a requested action. Said requested action could be a request from the RNC 101 to configure the radio link, specifically, for E-DCH and/or HS-DSCH setup or addition or up switch from DCH to E-DCH and/or HS-DSCH. Said request could be sent through a NBAP message (e.g., a RADIO LINK SETUP REQUEST message or a RADIO LINK ADDITION REQUEST message or a RADIO LINK RECONFIGURATION PREPARE message), and the failure cause could be included in a NBAP message (e.g., a RADIO LINK SETUP FAILURE message or a RADIO LINK ADDITION FAILURE message or a RADIO LINK RECONFIGURATION FAILURE message).

It should be appreciated that the above messages are described by way of example, and any suitable message can be used in this embodiment.

In step 304, the RNC 101 checks the exact failure cause from the received message, if the failure cause is “MaxNumEulUsers not available”, it may indicate that the allowed maximum of EUL user number of the RBS 102 is less than the corresponding configured parameter value in RNC 101, but the allowed maximum of HSPDA user number of the RBS 102 is sufficient, and if the cause is “MaxNumHsUsers not available”, it may indicate that at least the allowed maximum of HSDPA user number of the RBS 102 is less than the corresponding configured parameter value in RNC 101.

It should be appreciated that the above failure causes are described by way of example, and they could be rephrased similarly to indicate the actual meaning, or oppositely, as long as the RNC 101 knows its indication.

Optionally, in case that the allowed maximum of EUL user number of RBS 102 is smaller than the corresponding configured parameter value in RNC 101, the RNC 101 could generate an alarm to the operator telling this. Similarly, in case that said allowed maximum of HSDPA user number of RBS 102 is smaller than the corresponding configured parameter value in RNC 101, the RNC 101 could generate an alarm to the operator telling this. This is shown in step 306.

Optionally, the RNC 101 may suggest to the operator actions to expand said allowed maximum of EUL or of HSDPA user number of RBS 102 accordingly. The actions may be ordering higher capacity license for HSDPA or EUL user number or expanding configured value for the allowed maximum of EUL or of HSDPA user number of the RBS 102. This is shown in step 308.

It should be appreciated that the above actions are described by way of examples, and any suitable action can be taken in this embodiment.

Generally, the alarm option could be chosen by the operator and/or customer as desired, or be configured in any suitable way as appropriate.

Alternatively, the RNC 101 may take actions to automatically respond to the above cases in the embodiment, without intervening by the operator, and any suitable action can be performed in any suitable way in this embodiment.

Afterwards, if some actions have been taken to expand said allowed maximum of EUL or of HSDPA user number of RBS 102 accordingly, the RNC 101 may initiate the setup or addition or reconfiguration procedure again through a NBAP message (e.g., a RADIO LINK SETUP REQUEST message or a RADIO LINK ADDITION REQUEST message or a RADIO LINK RECONFIGURATION PREPARE message), and this time, the setup or addition or reconfiguration procedure may be fulfilled, and end with a NBAP message (e.g., a RADIO LINK SETUP RESPONSE message or a RADIO LINK ADDITION RESPONSE message or a RADIO LINK RECONFIGURATION READY message)(now shown).

The order in which some or all of the steps appear in each embodiment should not be deemed limiting. Rather, it should be understood by a person of ordinary skill in the art having the benefit of the instant disclosure that some of the step blocks may be executed in a variety of orders not illustrated.

As a whole, by means of adding new IEs in the RADIO LINK SETUP FAILURE message or RADIO LINK ADDITION FAILURE message or RADIO LINK RECONFIGURATION FAILURE message, the RNC 101 will be aware of the exact failure cause, and will reduce/avoid the useless/unnecessary attempting for HS-DSCH and/or E-DCH setup or addition or up switch from DCH to HS-DSCH and/or E-DCH. Meanwhile, with the alarm presented, the problem can be fixed pointedly and effectively.

FIG. 4 illustrates a flowchart of a method performed in RNC 101 in accordance with yet another embodiment. In step 402, the RNC 101 requests to configure both EUL and HSDPA radio links, specifically for E-DCH and HS-DSCH setup or addition or up switch from DCH to E-DCH and HS-DSCH. These two kinds of channels are requested in a single NBAP message in the prior art. Said request could be sent through a NBAP message (e.g., a RADIO LINK SETUP REQUEST message or a RADIO LINK ADDITION REQUEST message or a RADIO LINK RECONFIGURATION PREPARE message).

In step 404, the RNC 101 receives a message including the failure cause of the above requested action, and the failure cause could be included in a NBAP message (e.g., a RADIO LINK SETUP FAILURE message or a RADIO LINK ADDITION FAILURE message or a RADIO LINK RECONFIGURATION FAILURE message).

In step 406, the RNC 101 checks the exact failure cause from the received message, if the failure cause is “MaxNumEulUsers not available”, it may indicate that the allowed maximum of EUL user number of the RBS 102 is less than the corresponding configured parameter value in RNC 101, but the allowed maximum of HSPDA user number of the RBS 102 is sufficient, and if the cause is “MaxNumHsUsers not available”, it may indicate that at least the allowed maximum of HSDPA user number of the RBS 102 is less than the corresponding configured parameter value in RNC 101.

It should be appreciated that the above failure causes are described by way of example, and they could be rephrased similarly to indicate the actual meaning, or oppositely, as long as the RNC 101 knows its indication.

If it is determined in step 406 that the exact failure cause is that the allowed maximum of EUL user number of the RBS 102 is less than the corresponding configured parameter value in RNC 101, then in step 410, the RNC 101 could request to configure one or more HSDPA radio link(s), specifically for HS-DSCH setup or addition or up switch from DCH to HS-DSCH again through a NBAP message (e.g., a RADIO LINK SETUP REQUEST message or a RADIO LINK ADDITION REQUEST message or a RADIO LINK RECONFIGURATION PREPARE message). Otherwise, steps similar to 306 and/or 308 could be taken, and will not be iterated here. The steps of the embodiment hereinafter all refer to the scenario that the exact failure cause is that the allowed maximum of EUL user number of the RBS 102 is less than the corresponding configured parameter value in RNC 101.

Optionally, in case that the allowed maximum of EUL user number of RBS 102 is smaller than the corresponding configured parameter value in RNC 101, the RNC 101 could generate an alarm to the operator telling this. This is shown in step 408.

Optionally, the RNC 101 may suggest to the operator actions to expand said allowed maximum of EUL user number of RBS 102 accordingly. The actions may be ordering higher capacity license for EUL user number or expanding configured value for the allowed maximum of EUL user number of the RBS. This is shown in step 412.

It should be appreciated that the above messages are described by way of example, and any suitable message can be used in this embodiment.

It should be appreciated that the above actions are described by way of examples, and any suitable action can be taken in this embodiment, and that the above alarms could be separate alarms, or just one alarm telling both.

Generally, the alarm option could be chosen by the operator and/or customer as desired, or be configured in any suitable way as appropriate.

Alternatively, the RNC 101 may take actions to automatically respond to the above cases in the embodiment, without intervening by the operator, and any suitable action can be performed in any suitable way in this embodiment.

Afterwards, if some actions have been taken to expand said allowed maximum of EUL user number of RBS, the RNC 101 may initiate the setup or addition or reconfiguration procedure again through a NBAP message (e.g., a RADIO LINK SETUP REQUEST message or a RADIO LINK ADDITION REQUEST message or a RADIO LINK RECONFIGURATION PREPARE message), and this time, the setup or addition or reconfiguration procedure may be fulfilled, and end with a NBAP message (e.g., a RADIO LINK SETUP RESPONSE message or a RADIO LINK ADDITION RESPONSE message or a RADIO LINK RECONFIGURATION READY message) (now shown).

The order in which some or all of the steps appear in each embodiment should not be deemed limiting. Rather, it should be understood by a person of ordinary skill in the art having the benefit of the instant disclosure that some of the step blocks may be executed in a variety of orders not illustrated.

As a whole, by means of adding new IEs in the RADIO LINK SETUP FAILURE message or RADIO LINK ADDITION FAILURE message or RADIO LINK RECONFIGURATION FAILURE message, the RNC 101 will be aware of the exact failure cause, and will reduce/avoid the useless/unnecessary attempting for HS-DSCH and/or E-DCH setup or addition or up switch from DCH to HS-DSCH and/or E-DCH. Meanwhile, with the alarm presented, the problem can be fixed pointedly and effectively. Besides, with the exact failure cause, the RNC 101 could configure one ore more HSDPA radio link(s) if only EUL resource is limited in RBS in the embodiments of configuring both HSDPA and EUL radio links, thus enhancing the system performance.

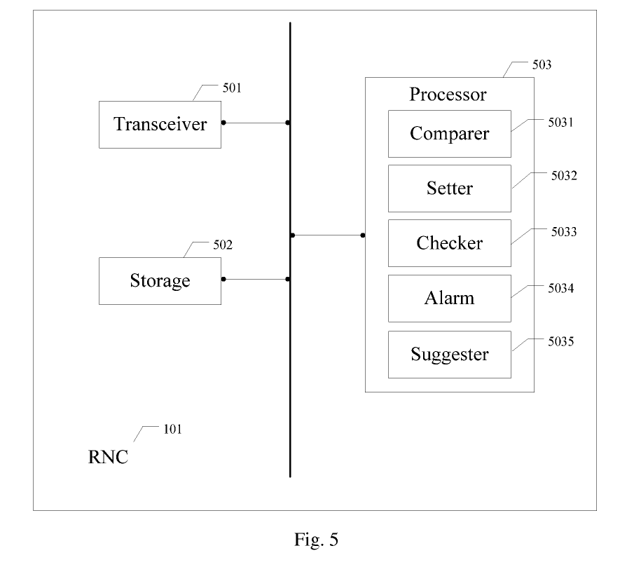

FIG. 5 illustrates a block diagram of a RNC 101 in accordance with one embodiment arranged to implement the above methods.

In FIG. 5, the RNC 101 comprises a transceiver 501, a storage 502 and a processor (503). It should be appreciated that the RNC 101 is not limited to the shown elements, and can comprise other conventional elements and the additional elements implemented for other purposes.

The storage 502 is configured to store information necessary for proper functioning of the RNC 101, including storing data used for capacity management. The transceiver 501 is responsible for sending and receiving messages to and from other devices coupled to it directly or via any suitable device or network. The processor (503) is configured at least to use information from received messages for capacity management.

Specifically, the processor (503) further comprises a comparer 5031 and a setter 5032, the comparer 5031 is configured for comparing two or more values to determine the bigger and the smaller, and the setter 5032 is configured for setting the parameter to a certain value.

Additionally or alternatively, the processor (503) further comprises a checker 5033, which is configured to analyze messages and data available to get an exact result, e.g., failure cause.

Additionally or alternatively, the processor (503) further comprises an alarm 5034, which is configured to generate an alarm to warn something, e.g., allowed maximum of EUL and/or of HSDPA user number of said RBS 102 is less than configured parameter value of maximum of EUL and/or of HSDPA user number in said RNC 101 correspondingly.

Additionally or alternatively, the processor (503) further comprises a suggester 5035, configured to give suggestions to the operator, e.g., to suggest actions to expand allowed maximum of EUL and/or of HSDPA user number of a RBS 102.

The elements 5031-5035 are illustrated as separate elements in FIG. 5. However, this is merely to indicate that the functionalities are separated. The elements can be provided as separate hardware devices. However, other arrangements are possible. Any combination of the elements can be implemented in any combination of software, hardware, and/or firmware in any suitable location. For example, there could be more processors working together, implemented locally or distributed among several devices coupled together through network, with each processor having one or more of the components (e.g., comparers, setters, etc.) shown.

The elements may constitute machine-executable instructions embodied within a machine, e.g., readable medium, which when executed by a machine will cause the machine to perform the operations described. Besides, any of the elements may be implemented as a hardware, such as an application specific integrated circuit (ASIC), Digital Signal Processor (DSP), Field Programmable Gate Array (FPGA) or the like.

Besides, it should be understood that this and other arrangements described herein are set forth only as examples. Other arrangements and elements (e.g., user interface, more processors, comparers, setters, etc.) can be used in addition to or instead of those shown, and some elements may be omitted altogether.

Functionalities and cooperation between these elements are described in detail in the following.

In one embodiment, the transceiver 501 receives a message including an allowed maximum of EUL and/or of HSDPA user number of RBS. In one example, the message is an AUDIT RESPONSE message sent from the RBS, in response to an AUDIT REQUEST message sent from the RNC 101 to the RBS 102. Alternatively, the message could be a RESOURCE STATUS INFORMATION message sent from the RBS. Both messages are NBAP messages, and new IEs of allowed maximum of EUL and of HSDPA user number of RBS should be added to the NBAP messages.

It should be appreciated that the above messages is described by way of example, and any suitable message can be used in this embodiment.

Then the allowed maximum of EUL and/or of HSDPA user number of RBS 102 is recorded in the storage 502. Alternatively, if an allowed maximum of EUL and/or of HSDPA user number of RBS 102 has already been recorded in the storage 502, then the value in the storage 502 is updated.

Afterwards, in the comparer 5031, a comparison is made between said allowed maximum of EUL user number of RBS 102 with corresponding configured parameter (e.g., termed as “max number of EUL user”) for maximum of EUL user number in RNC 101, and/or a comparison is made between said allowed maximum of HSDPA user number of RBS 102 with corresponding configured parameter (e.g., termed as “max number of HSDPA user”) for maximum of HSDPA user number in RNC 101, to determine the smaller value.

It should be appreciated that the above parameters could be rephrased similarly to indicate the actual meaning, or oppositely, as long as the RNC 101 knows its representation.

Then the setter 5032 sets the admission control value(s) for maximum of EUL and/or of HSDPA user number to the smaller value(s) from the comparer 5031 correspondingly.

Optionally, in case that said allowed maximum of EUL user number of RBS 102 is smaller than the configured value in RNC 101, the alarm 5034 could generate an alarm to the operator telling this. Similarly, in case that said allowed maximum of HSDPA user number of RBS 102 is smaller than the configured value in RNC 101, the alarm 5034 could generate an alarm to the operator telling this.

Optionally, the suggester 5035 may suggest to the operator actions to expand said allowed maximum of EUL and/or of HSDPA user number of RBS 102 accordingly. The actions may be ordering higher capacity license for HSDPA and/or EUL user number or expanding configured value for the allowed maximum of EUL and/or of HSDPA user number of the RBS.

It should be appreciated that the above actions are described by way of examples, and any suitable action can be taken in this embodiment, and that the above alarms could be separate alarms, or just one alarm telling both.

Generally, the alarm option could be chosen by the operator and/or customer as desired, or be configured in any suitable way as appropriate.

Alternatively, the RNC 101 may take actions to automatically respond to the above cases in the embodiment, without intervening by the operator, and any suitable action can be performed in any suitable way in this embodiment. The element to perform this function is not shown in the figure.

Besides, said configured parameter values and the admission control values are stored in the storage 502.

It requires the RBS 102 to be configured to send above messages received by the RNC 101 and receive the above messages sent by the RNC 101, and the RBS 102 may have a generator configured to generate the above messages received by the RNC 101 and a transceiver configured to send and receive messages, including the above mentioned messages.

As a whole, by means of cooperation between the RNC 101 and the RBS, the RNC 101 can add said allowed maximum of EUL and/or of HSDPA user number of the RBS 102 as one of the evaluated criteria in its own admission control, then useless attempting for channel switch from DCH to E-DCH/HS-DSCH will be avoided, resulting in a more accurate and highly effective admission control. Besides, RNC 101 and RBS 102 will be more supportive of the admission, obviating dispensable failures, thus rendering the RNC 101 and RBS 102 more flexible and robust. Meanwhile, with the alarm presented, the system efficiency can be improved pointedly and effectively.

In another embodiment, the transceiver 501 receives a message including the failure cause of a requested action. Said requested action could be a request sent from the RNC's transceiver 501 to setup or add or reconfigure the radio link, specifically, for E-DCH and/or HS-DSCH setup or addition or up switch from DCH to E-DCH and/or HS-DSCH. Said request could be sent through a NBAP message (e.g., a RADIO LINK SETUP REQUEST message or a RADIO LINK ADDITION REQUEST message or a RADIO LINK RECONFIGURATION PREPARE message), and the failure cause could be included in a NBAP message (e.g., a RADIO LINK SETUP FAILURE message or a RADIO LINK ADDITION FAILURE message or a RADIO LINK RECONFIGURATION FAILURE message).

It should be appreciated that the above messages are described by way of example, and any suitable message can be used in this embodiment.

Then, the checker 5033 checks the exact failure cause from the received message, if the failure cause is “MaxNumEulUsers not available”, it may indicate that the allowed maximum of EUL user number of the RBS 102 is less than the corresponding configured parameter value in RNC 101, but the allowed maximum of HSPDA user number of the RBS 102 is sufficient, and if the cause is “MaxNumHsUsers not available”, it may indicate that at least the allowed maximum of HSDPA user number of the RBS 102 is less than the corresponding configured parameter value in RNC 101.

It should be appreciated that the above failure causes are described by way of example, and they could be rephrased similarly to indicate the actual meaning, or oppositely, as long as the RNC 101 knows its indication.

Optionally, in case that the allowed maximum of EUL user number of RBS 102 is smaller than the corresponding configured parameter value in RNC 101, the alarm 5034 could generate an alarm to the operator telling this. Similarly, in case that said allowed maximum of HSDPA user number of RBS 102 is smaller than the corresponding configured parameter value in RNC 101, the alarm 5034 could generate an alarm to the operator telling this.

Optionally, the suggester 5035 may suggest to the operator actions to expand said allowed maximum of EUL or of HSDPA user number of RBS 102 accordingly. The actions may be ordering higher capacity license for HSDPA or EUL user number or expanding configured value for the allowed maximum of EUL or of HSDPA user number of the RBS.

It should be appreciated that the above actions are described by way of examples, and any suitable action can be taken in this embodiment.

Generally, the alarm option could be chosen by the operator and/or customer as desired, or be configured in any suitable way as appropriate.

Alternatively, the RNC 101 may take actions to automatically respond to the above cases in the embodiment, without intervening by the operator, and any suitable action can be performed in any suitable way in this embodiment. The element to perform this function is not shown in the figure.

Afterwards, if some actions have been taken to expand said allowed maximum of EUL or of HSDPA user number of RBS 102 accordingly, the transceiver 501 may send a NBAP message (e.g., a RADIO LINK SETUP REQUEST message or a RADIO LINK ADDITION REQUEST message or a RADIO LINK RECONFIGURATION PREPARE message) to setup or add or reconfigure again, and this time, the setup or addition or reconfiguration procedure may be fulfilled, and end with a NBAP message (e.g., a RADIO LINK SETUP RESPONSE message or a RADIO LINK ADDITION RESPONSE message or a RADIO LINK RECONFIGURATION READY message) received by the transceiver 501.

Besides, said configured parameter value is stored in the storage 502.

It requires the RBS 102 to be configured to send above messages received by the RNC 101 and receive the above messages sent by the RNC 101, and the RBS 102 may have a generator configured to generate the above messages received by the RNC 101 and a transceiver configured to send and receive messages, including the above mentioned messages.

As a whole, by means of adding new IEs in the RADIO LINK SETUP FAILURE message or RADIO LINK ADDITION FAILURE message or RADIO LINK RECONFIGURATION FAILURE message, the RNC 101 will be aware of the exact failure cause, and will reduce/avoid the useless/unnecessary attempting for HS-DSCH and/or E-DCH setup or addition or up switch from DCH to HS-DSCH and/or E-DCH. Meanwhile, with the alarm presented, the problem can be fixed pointedly and effectively.

In still another embodiment, the transceiver 501 requests to configure both EUL and HSDPA radio links, specifically for E-DCH and HS-DSCH setup or addition or up switch from DCH to E-DCH and HS-DSCH. These two kinds of channels are requested in a single NBAP message in the prior art. Said request could be sent through a NBAP message (e.g., a RADIO LINK SETUP REQUEST message or a RADIO LINK ADDITION REQUEST message or a RADIO LINK RECONFIGURATION PREPARE message).

Then the transceiver 501 receives a message including the failure cause of the above requested action, and the failure cause could be included in a NBAP message (e.g., a RADIO LINK SETUP FAILURE message or a RADIO LINK ADDITION FAILURE message or a RADIO LINK RECONFIGURATION FAILURE message).

Afterwards, the checker 5033 checks the exact failure cause from the received message, if the failure cause is “MaxNumEulUsers not available”, it may indicate that the allowed maximum of EUL user number of the RBS 102 is less than the corresponding configured parameter value in RNC 101, but the allowed maximum of HSPDA user number of the RBS 102 is sufficient, and if the cause is “MaxNumHsUsers not available”, it may indicate that at least the allowed maximum of HSDPA user number of the RBS 102 is less than the corresponding configured parameter value in RNC 101.

It should be appreciated that the above failure causes are described by way of example, and they could be rephrased similarly to indicate the actual meaning, or oppositely, as long as the RNC 101 knows its indication.

If it is determined in the checker 5033 that the exact failure cause is that the allowed maximum of EUL user number of the RBS 102 is less than the corresponding configured parameter value in RNC 101, then the RNC 101 may request to configure one or more HSDPA radio link(s), specifically for HS-DSCH setup or addition or up switch from DCH to HS-DSCH again through a NBAP message (e.g., a RADIO LINK SETUP REQUEST message or a RADIO LINK ADDITION REQUEST message or a RADIO LINK RECONFIGURATION PREPARE message) sent by the transceiver 501. Optionally, in case that the allowed maximum of EUL user number of RBS 102 is smaller than the corresponding configured parameter value in RNC 101, the alarm 5034 could generate an alarm to the operator telling this.

Optionally, the suggester 5035 may suggest to the operator actions to expand said allowed maximum of EUL user number of RBS 102 accordingly. The actions may be ordering higher capacity license for EUL user number or expanding configured value for the allowed maximum of EUL user number of the RBS.

It should be appreciated that the above messages are described by way of example, and any suitable message can be used in this embodiment.

It should be appreciated that the above actions are described by way of examples, and any suitable action can be taken in this embodiment, and that the above alarms could be separate alarms, or just one alarm telling both.

Generally, the alarm option could be chosen by the operator and/or customer as desired, or be configured in any suitable way as appropriate.

Alternatively, the RNC 101 may take actions to automatically respond to the above cases in the embodiment, without intervening by the operator, and any suitable action can be performed in any suitable way in this embodiment. The element to perform this function is not shown in the figure.

Afterwards, if some actions have been taken to expand said allowed maximum of EUL user number of RBS, the RNC 101 may initiate the setup or addition or reconfiguration procedure again through a NBAP message (e.g., a RADIO LINK SETUP REQUEST message or a RADIO LINK ADDITION REQUEST message or a RADIO LINK RECONFIGURATION PREPARE message) sent by the transceiver 501, and this time, the setup or addition or reconfiguration procedure may be fulfilled, and end with a NBAP message (e.g., a RADIO LINK SETUP RESPONSE message or a RADIO LINK ADDITION RESPONSE message or a RADIO LINK RECONFIGURATION READY message) received through the transceiver 501.

Besides, said configured parameter values are stored in the storage 502.

It requires the RBS 102 to be configured to send above messages received by the RNC 101 and receive the above messages sent by the RNC 101, and the RBS 102 may have a generator configured to generate the above messages received by the RNC 101 and a transceiver configured to send and receive messages, including the above mentioned messages.

As a whole, by means of adding new IEs in the RADIO LINK SETUP FAILURE message or RADIO LINK ADDITION FAILURE message or RADIO LINK RECONFIGURATION FAILURE message, the RNC will be aware of the exact failure cause, and will reduce/avoid the useless/unnecessary attempting for HS-DSCH and/or E-DCH setup or addition or up switch from DCH to HS-DSCH and/or E-DCH. Meanwhile, with the alarm presented, the problem can be fixed pointedly and effectively. Besides, with the exact failure cause, the RNC could configure one or more HSDPA radio link(s) if only EUL resource is limited in the embodiment of configuring both HSDPA and EUL radio links, thus enhancing the system performance.

While the embodiments have been illustrated and described herein, it will be understood by those skilled in the art that various changes and modifications may be made, and equivalents may be substituted for elements thereof without departing from the true scope of the present technology. In addition, many modifications may be made to adapt to a particular situation and the teaching herein without departing from its central scope. Therefore it is intended that the present embodiments not be limited to the particular embodiment disclosed as the best mode contemplated for carrying out the present technology, but that the present embodiments include all embodiments falling within the scope of the appended claims.

1-24. (canceled)

25. A method performed in a Radio Network Controller (RNC) in a radio communication network including at least one RNC and at least one Radio Base Station (RBS) and a plurality of user equipments (UEs), the method comprising:
receiving a message that includes information about a number of users for Enhanced Uplink (EUL) or High Speed Downlink Packet Access (HSDPA), or both, for said RBS;
using said information for the RNC's capacity management.

26. The method of claim 25, wherein said information includes an allowed maximum number of users for EUL or HSDPA, or both, for said RBS.

27. The method of claim 26, further comprising:
comparing said allowed maximum number of users of EUL or HSDPA, or both, with a corresponding configured value or values for a maximum number of users in said RNC of EUL or HSDPA, or both; and
setting an admission control value or values for a maximum number of users of EUL or HSDPA, or both, to the smaller of the allowed maximum number or numbers and the corresponding configured value or values.

28. The method of claim 26, wherein said message is an AUDIT RESPONSE message or a RESOURCE STATUS INFORMATION message.

29. The method of claim 27, further comprising:
generating an alarm indicating that said allowed maximum number of users of EUL or HSDPA, or both, for said RBS, is less than said configured value of maximum number of users in said RNC of EUL or HSDPA, or both, in the event that the number of users of EUL or HSDPA, or both, in said message is smaller than said configured value of maximum number of user in said RNC of EUL or HSDPA, or both, correspondingly.

30. The method of claim 25, wherein said information includes a failure cause indicating that said allowed maximum number of users of EUL or HSDPA, or both, for said RBS, is less than said configured value for a maximum number of users in said RNC of EUL or HSDPA, or both, correspondingly.

31. The method of claim 30, wherein said message is a RADIO LINK SETUP FAILURE message or a RADIO LINK ADDITION FAILURE message or a RADIO LINK RECONFIGURATION FAILURE message.

32. The method of claim 30, further comprising:
checking an exact failure cause from said information; and
generating an alarm telling the exact failure cause.

33. The method of claim 32, further comprising, when said message corresponds to a request to configure both EUL and HSDPA radio links and it is determined in the checking step that only said EUL radio link configuration failed due to limitation of said allowed maximum number of users of EUL or HSDPA, or both, for said RBS:
requesting to configure one or more HSDPA radio links; and
said exact failure cause is that said allowed maximum number of users of EUL or HSDPA, or both, for said RBS, is less than said configured value for a maximum number of users in said RNC of EUL or HSDPA, or both.

34. The method of claim 32, further comprising suggesting actions to expand said allowed maximum number of users of EUL or HSDPA, or both, for said RBS, correspondingly.

35. The method of claim 34, wherein said actions are ordering higher capacity license for HSDPA or EUL use or expanding configured value for said allowed maximum number of users of EUL or HSDPA, or both, for said RBS.

36. A Radio Network Controller (RNC) in a radio communication network including at least one RNC and at least one Radio Base Station (RBS) and a plurality of user equipments (UEs), the RNC comprising:
a transceiver configured to send and receive messages, and in particular to receive a message that has information about a number of users for Enhanced Uplink (EUL) or High Speed Downlink Packet Access (HSDPA), or both, for said RBS;
a storage configured to store information used by said RNC;
a processor configured to use, for capacity management, said information about a number of users for Enhanced Uplink (EUL) or High Speed Downlink Packet Access (HSDPA), or both, for said RBS.

37. The device of claim 36, wherein said processor further comprises:
a comparer configured to compare, correspondingly, an allowed maximum number of users of EUL or HSDPA, or both, for said RBS, with a configured value for a maximum number of users in said RNC of EUL or HSDPA, or both, stored in said storage, in the event that said information about a number of users for Enhanced Uplink (EUL) or High Speed Downlink Packet Access (HSDPA), or both, for said RBS is said allowed maximum number of users of EUL or HSDPA, or both, for said RBS; and
a setter configured to set an admission control value or values for a maximum number of users of EUL or HSDPA, or both, to the corresponding smaller one or ones of the allowed maximum number and configured value.

38. The device of claim 36, further comprising:
a checker configured to check an exact failure cause in case that said information is a failure cause indicating that the allowed maximum number of users of EUL or HSDPA, or both, for said RBS is less than said configured value of maximum number of user in said RNC of EUL or HSDPA, or both, correspondingly.

39. The device of claim 37, further comprising:
an alarm configured to generate an alarm indicating that said allowed maximum number of users of EUL or HSDPA, or both, for said RBS is less than said configured value of maximum number of user in said RNC of EUL or HSDPA, or both, in case that said comparer has determined that said allowed maximum number of users of EUL or HSDPA, or both, for said RBS is less than said configured value of maximum number of user in said RNC of EUL or HSDPA, or both, correspondingly, or in case that said checker has checked that the exact failure cause is that said allowed maximum number of users of EUL or HSDPA, or both, for said RBS is less than said configured value of maximum number of user in said RNC of EUL or HSDPA, or both, correspondingly.

40. The device of claim 39, wherein if said failure cause corresponds to a request to configure both EUL and HSDPA radio links, and if it is determined by the checker that only said EUL radio link configuration failed due to limitation of said allowed maximum of EUL user number of said RBS, then:
said transceiver is further configured to request to configure one or more HSDPA radio links, and
said alarm is configured to generate an alarm indicating that said allowed maximum of EUL user number of said RBS is less than said configured value for a maximum number of users in said RNC of EUL or HSDPA, or both.

41. The device of claim 39, further comprising:
a suggester configured to suggest actions to expand said allowed maximum number of users of EUL or HSDPA, or both, for said RBS, correspondingly.

42. The device of claim 41, wherein said actions are ordering higher capacity license for HSDPA or EUL use or expanding configured value for said allowed maximum number of users of EUL or HSDPA, or both, for said RBS.

43. A method performed in a Radio Base Station (RBS) in a radio communication network including at least one Radio Network Controller (RNC) and at least one RBS, and a plurality of user equipments (UEs), the method comprising:
generating a message that has information about a number of users for Enhanced Uplink (EUL) or High Speed Downlink Packet Access (HSDPA), or both, for said RBS; and
sending said message.

44. The method of claim 43, wherein said information includes an allowed maximum number of users of EUL or HSDPA, or both, for said RBS, which is sent in an AUDIT RESPONSE Message or a RESOURCE STATUS INFORMATION message, or a failure cause indicating that said allowed maximum number of users of EUL or HSDPA, or both, for said RBS is less than a configured value for a maximum number of users in said RNC of EUL or HSDPA, or both, correspondingly, which is sent in a RADIO LINK SETUP FAILURE message or a RADIO LINK ADDITION FAILURE message or a RADIO LINK RECONFIGURATION FAILURE message.

45. A Radio Base Station (RBS) in a radio communication network including at least one Radio Network Controller (RNC) and at least one RBS, and a plurality of user equipments (UEs) comprising:
a generator, configured to generate a message that has information for said RBS about a number of users for Enhanced Uplink (EUL) or High Speed Downlink Packet Access (HSDPA), or both; and
a transceiver, configured to send said message.

46. The device of claim 45, wherein said information includes an allowed maximum number of users of EUL or HSDPA, or both, for said RBS, which is sent in an AUDIT RESPONSE Message or a RESOURCE STATUS INFORMATION message, or a failure cause indicating that the allowed maximum number of users of EUL or HSDPA, or both, for said RBS is less than a configured value for a maximum number of users in said RNC of EUL or HSDPA, or both, which is sent in a RADIO LINK SETUP FAILURE message or a RADIO LINK ADDITION FAILURE message or a RADIO LINK RECONFIGURATION FAILURE message.

47. A non-transitory computer-readable medium having stored thereupon instructions that, when executed by a processor, cause the processor to implement the operations of claim 1.
